(19) United States
(12) Patent Application Publication
(10) Pub. No.: US 2007/0003025 A1
(43) Pub. Date: Jan. 4, 2007

(54) RYBENA: AN ASL-BASED COMMUNICATION METHOD AND SYSTEM FOR DEAF, MUTE AND HEARING IMPAIRED PERSONS

(75) Inventors: Clesio da Cruz Alves, Brasilia (BR); Jose Carlos de Castro Waeny JR., Brasilia (BR)

Correspondence Address: INSTITUTO CT5, TERRACO SHOPPING - TORRE, A SALA 404, BRASILIA, 70660-020, BR

(73) Assignee: INSITITUTO CENTRO DE PESQUISA E DESENVOLVIMENTO EM, Brasilia (BR)

(21) Appl. No.: 11/163,197

(22) Filed: Oct. 10, 2005

(30) Foreign Application Priority Data
Jun. 24, 2005 (BR) PI0502931-7

(51) Int. Cl. H04M 11/00

(52) U.S. Cl. 379/52

(57) ABSTRACT

Rybena is both a system and a method that makes it feasible the communication between deaf, hearing impaired and mute persons and other people in general, including handicapped and those not similarly handicapped. The system makes use of some techniques in order to reduce the English language, written or spoken, to a formal text that can be distributed by electronic means and translated to ASL (American Sign Language). That reduced text is a meta-language that can be conveyed, using distinct communication channels, to varied devices, like cell phones and digital assistants, and presented in text, voice or animated ASL.

Rybena is both a system and a method that makes it feasible the communication between deaf, hearing impaired and mute persons and other people in general, including handicapped and those not similarly handicapped. The word Rybena, from the Xavante language spoken by a Brazilian Indian tribe, means “to communicate”, and this is, in general terms, the aim of the aforesaid system.

Specifically, the system makes use of some techniques in order to reduce the English language, written or spoken, to a formal text that can be distributed by electronic means and translated to ASL (American Sign Language) in the form of animated images. That reduced text is a meta-language that can be conveyed, using distinct communication channels, to varied devices, even mobile ones. In these devices is deployed a component of the system which goal is to show the message in animated ASL.

It is worth mentioning that ASL is not signaled English and there is not an available device capable of presenting, in its human-machine interface, an ASL formatted message. Searches made in the Internet did not reveal any kind of invent with similar functions as those proposed by Rybena. It is an evidence of Rybena's innovation.

Historically, deaf, hearing impaired and mute persons have faced difficulties when communicating, both among themselves and with others not similarly handicapped. In fact, as the number of persons fluent in ASL is so small, it is even more difficult to establish a conversation between a non-handicapped person and one that is deaf or mute.

Even when dealing with public-sector entities, the audible handicapped community is in trouble by the lack of ASL translators. It gets worse in simple activities like airport check in, market purchases and other social relations that take place mainly in the private sector.

The goal intended to be attained by the present invention is the use of technology to help the disabled to minimize the communication difficulties they deal with daily. The practical use of this invention can be envisioned in many industrial branches, notably in the telecoms.

Recent advances in voice recognition and synthesis, pervasive use of graphical user interface devices and speed up in database information retrieval are factors enabling the present invention.

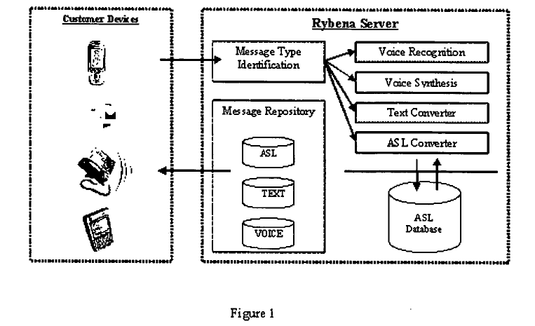

FIG. 1 illustrates the components architecture of the Rybena system.

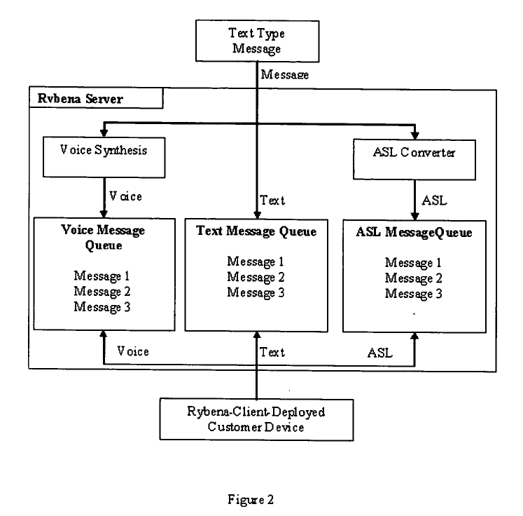

FIG. 2 is a flow diagram illustrating the message flow initiated by a text message, in accordance with an embodiment of the present invention.

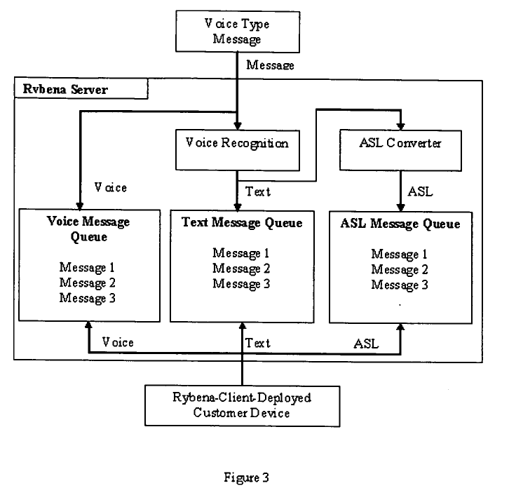

FIG. 3 is a flow diagram illustrating the message flow initiated by a voice message, in accordance with an embodiment of the present invention.

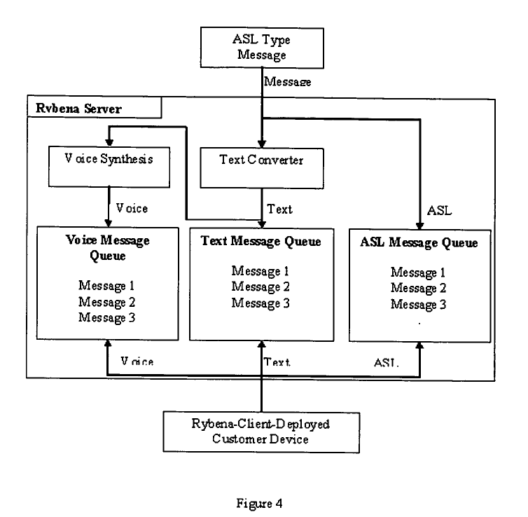

FIG. 4 is a flow diagram illustrating the message flow initiated by an ASL message, in accordance with an embodiment of the present invention.

The system and method of the present invention are detailed below.

As shown in FIG. 1, the Rybena system is made up of two subsystems: client and server.

The FIGS. 2, 3 and 4 are used to detail the message flow in the communication process between a hearing impaired person and one who have severe visual impairments or a listener.

The message flow can be broken down in the following phases:

(1) Sending of the message: initially, a message from the customer device (cell phone, PDA etc) is received by the server module. It can be a text, voice or ASL message. Text and voice messages can be sent by any customer device but ASL messages can only be sent by devices where the client module was previously deployed;

(2) Identification of the message: as already mentioned, the message can be codified in 3 formats: text, voice and ASL. For each of them, a specific treatment will occur;

(3) Treatment of the message:

Text type message (FIG. 2): the text type message is stored in a text message queue. Later, this message is contextualized and sent to the ASL message queue. The text message is then translated to the voice format using a voice synthesis process. The resulting voice message is sent to the voice message queue;
Voice type message (FIG. 3): the voice type message is stored in a voice message queue. Later, this message is translated to the text format using a voice recognition technique. The resulting text is sent to the text message queue. The text message is then contextualized (translation and conversion to the ASL language) and sent to the ASL message queue;
ASL type message (FIG. 4): the ASL type message is stored in an ASL message queue. Later, this message is translated to the text format and sent to the text message queue. The text message is then translated to the voice format using a voice synthesis process. The resulting voice message is sent to the voice message queue;
   (4) Message retrieval: The communication process completes when a message from a client is recovered by an addressee in a format that satisfy his needs (text, voice or ASL).

The module named contextualization is responsible for the English text reduction (suppression of all the prepositions), for the analysis of expressions and for the verbal reduction.

In the verbal reduction, the verbs are reduced to its infinitive form along with an indicator of the grammatical tense that will be used later on the ASL signaling method.

Through the analysis of the sentence terms is made a correspondence with what we call ASL expressions. For example, in ASL the set “can not” does not correspond to the sign “not” plus the sign “can”. There are distinct signs for “can”, “not” and “cannot”.

What is claimed is:

1. Method and system that makes it feasible the communication between deaf, hearing impaired and mute persons and other people in general, including handicapped and those not similarly handicapped, characterized by the use of some techniques in order to reduce the English language, written or spoken, without human intervention, to a formal text that can be distributed by electronic means and translated to ASL (American Sign Language) in the form of animated images.

2. The system of claim 1 comprises the client and Server subsystems. The Server subsystem is composed of the modules:
a) voice-recognition module, responsible for the conversion of a voice message to a text message;
b) voice-synthesis module, responsible for the conversion of a text message to a voice message;
c) ASL-conversion module, responsible for the conversion of a text message to an ASL-animated message;
d) text-conversion module, responsible for the conversion of an ASL-animated message to a text message;
e) queue-management module for managing the text, voice and ASL queues;
f) module for controlling, identifying and authorizing message traffic among users;
g) voice-messages repository, responsible for storing voice-type messages;
h) text-messages repository, responsible for storing text-type messages;
i) ASL-messages repository, responsible for storing ASL-type messages;
j) ASL-animated images repository. Each animated image represents an ASL-language sign;
k) monitoring and event notification module;
The Client subsystem is composed of the following modules:
a) text-capture module for reading text messages inputted in the user device interface (cell phone, PDA, PC etc);
b) module for capturing voice messages, via a microphone, and reducing noise rates by the use of filtering techniques;
c) module for capturing ASL messages;
d) module for message conversion and compacting to reduce the amount of transmitted data;
e) security module for message confidentiality assurance by the use of cryptographic techniques;
f) message transmission module using as communication channels the Internet and PSTN or mobile phone networks (technologies such as X.25, ATM, frame relay, TCP/IP, GPRS, CDMA, among others);
g) module for retrieving messages in the text, voice or ASL formats, configured in accordance with user needs (physical unfitness);
h) module for the making of ASL-animated images and its presentation, using time measures (ASL-signs exhibition time and pause time between signs);
i) module for the exhibition of text messages;
j) module for playing audio messages;
k) module for retrieving voice messages stored in the server repository from a telephone.

3. The communication method of claim 1, characterized by the transmission of a message in the voice, text or ASL formats from a customer device (cell phone, PDA, Personal Computer etc) to the server subsystem that initially identifies the format, comprising the steps of:
a) if the message is in the voice format, it is stored in the voice message queue. Afterwards, this incoming message is translated to text using a voice recognition technique. The translation process resulting text is sent to the text message queue. The text message is then contextualized (translation and conversion to the ASL language) and sent to the ASL message queue;
b) if the message is in the text format, it is stored in the text message queue. Later, this message is contextualized and sent to the ASL message queue. The text message is then translated to the voice format using a voice synthesis process. The resulting voice message is sent to the voice message queue;
c) if the message is in the ASL format, it is stored in the ASL message queue. Later, this message is translated to the text format and sent to the text message queue. The text message is then translated to the voice format using a voice synthesis process. The resulting voice message is sent to the voice message queue;
The communication method is accomplished when the addressee retrieves the message sent by a client in the format he considers fits his needs better (text, voice or ASL).

4. The method of claim 1 and 3 wherein said conversion to ASL is characterized by message semantic analysis and contextualization. The non-essential linguistic structures to the to ASL language translation process, like prepositions, are removed. The expressions are verified and the verbal reduction takes place (the verbs are reduced to its infinitive form along with an indicator of the grammatical tense that will be used later on the ASL signaling method).

5. The method of claim 1 and 3 wherein said ASL signaling is characterized by image retrieval, stored either in the customer device or in the server subsystem. With the images available in the customer device an animation will be created making use of time measures (exhibition time of ASL signs and pause time between signs) and the resulting ASL-animated message will be displayed in the customer device graphical user interface.
